(19) United States
(12) Patent Application Publication
(10) Pub. No.: US 2005/0086103 A1
(43) Pub. Date: Apr. 21, 2005

(54) Electronic shopping cart for transactions

(75) Inventors: Vivian Agura, Wilton, CT (US); Chris Munkacsy, Hamilton, NJ (US); Trey Neemann, Glendale, AZ (US); Jena Francis, New York, NY (US)

Correspondence Address: SNELL & WILMER;ONE ARIZONA CENTER, 400 EAST VAN BUREN, PHOENIX, AZ, 850040001, US

(73) Assignee: American Express Travel Related Services Company, Inc.

(21) Appl. No.: 10/688,628

(22) Filed: Oct. 17, 2003

(51) Int. Cl. G06F 17/60

(52) U.S. Cl. 705/14; 705/26

(57) ABSTRACT

A system and method for redeeming loyalty points for transactions that may include non-tangible and tangible items. The transactions are collected in an electronic shopping cart as the user browses various items. Once the user completes the collection of transactions, the user may proceed to checkout. Upon checkout, the system processes each transaction in the shopping cart and contacts third party partners and other entities as necessary to complete the transaction.

### 1. TECHNICAL FIELD

The present invention relates generally to electronic shopping carts, and more particularly, to a method and system for redeeming loyalty points for various types of transactions that are collected in an electronic shopping cart.

### 2. BACKGROUND INFORMATION

Traditional loyalty (e.g., incentive award, frequency reward, etc.) programs have been around for many years. Loyalty programs are typically used to help businesses develop and maintain participant loyalty and are often used as marketing tools to develop new clientele. A frequent flyer program is an example of a typical loyalty program, where the more the participant uses a particular airline or group of affiliated airlines, the more frequent flyer miles the participant earns. After accumulating frequent flyer miles, the participant may choose to redeem those miles for upgrades in service or free airline tickets. Various forms of these programs have developed over the years, ranging from programs such as “buy 9 get one 1” punch cards to more sophisticated credit card loyalty systems, where participants are awarded points for using a particular transaction card and/or for using a transaction card with particular merchants or vendors.

As competition in various markets increased, companies sought ways to expand loyalty programs to appeal to a broader cross-section of potential customers. One way this was accomplished was by developing strategic partnerships and affiliations with other business sectors. For example, hotel chains, airlines and rental car agencies developed loyalty program partnerships and affiliations; credit and transaction card companies also joined in to promote a more comprehensive and appealing loyalty program.

Online, interactive frequency and award redemption programs have been developed which immediately award and issue bonus points to a user's awards account in response to that user's on-line purchase of merchandise. In other words, submission of a purchase order form during an on-line session results in the calculation and addition of points to an enrolled user's account as well as the display of current account information. The user is then immediately permitted to redeem any or all of the award points in the user's account, including currently awarded points, in that same on-line session. These systems are specifically directed to the award and redemption of points for merchandise that may be offered directly by the account provider or its partners.

Other systems relate to incentive award programs which allocate monetary amounts of credit based on a participant's performance of a designated level of achievement. The monetary amounts can be withheld and/or adjusted by a sponsoring company. Although these systems allow for the crediting of a monetary value to a credit instrument, they are limited in that the participant is not able to interact over a computerized network so as to effect a real-time transaction or to effect a real-time credit to a credit instrument.

Although many of these programs have been successful in developing customer loyalty and providing incentives for customers to act, they have presented participants with limited opportunities to redeem loyalty points for the items of their choice or have provided participants with limited accessibility and control of their loyalty account. Therefore, a need exists in this industry for on-line programs that expand item choices and provide enhanced functionality for on-line loyalty program participants.

### BRIEF DESCRIPTION OF THE DRAWINGS

A more complete understanding of the present invention may be derived by referring to the detailed description when considered in connection with the Figures, wherein like reference numbers refer to similar elements throughout the Figures, and:

FIG. 1 illustrates exemplary components of the present invention;

FIG. 2 illustrates a schematic overview of the exemplary phases of the present invention; and

FIGS. 3-5 are web page screen shots depicting an exemplary on-line embodiment of the present invention.

### DETAILED DESCRIPTION OF EXEMPLARY EMBODIMENTS

In general, the present invention uniquely integrates a loyalty program and the financial transaction systems of a transaction card provider (“transaction system”) to more effectively use loyalty points to facilitate the processing and completion of transactions for tangible and/or non-tangible items. Specifically, the system and methods described herein allow an individual to redeem loyalty points (such as points awarded to a participant in the American Express Membership Rewards® Program) for transactions that may include non-tangible items (e.g., frequent flyer mileage, charity donations, trips, and cruises) and/or tangible items (i.e., merchandise). This system not only provides a mechanism for redeeming loyalty points for non-tangible and tangible items, but in certain embodiments, it also comprises utilizing an electronic shopping cart to collect a series of dependent or independent transactions for the non-tangible and tangible items prior to completing the transactions for the items.

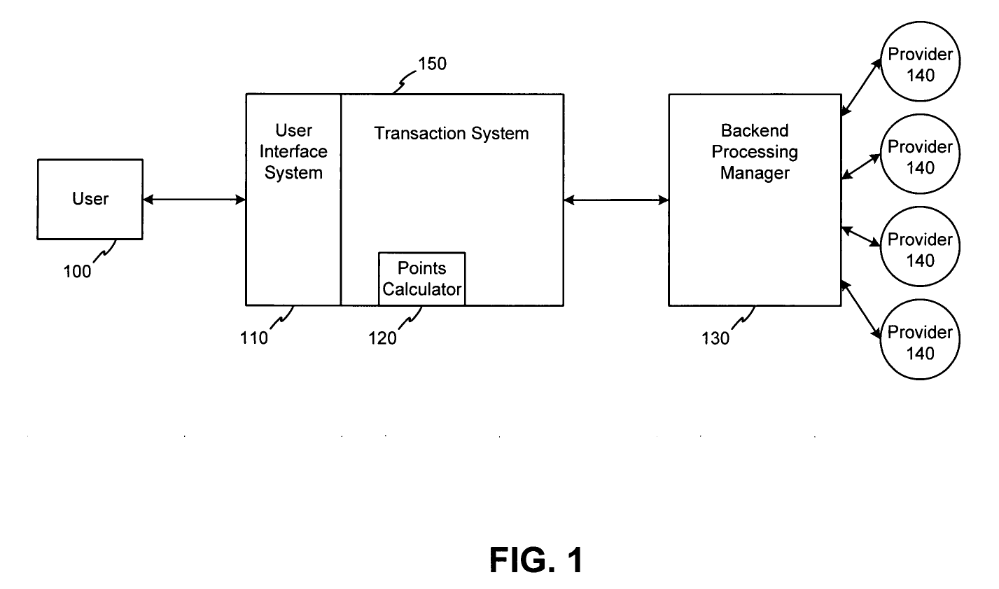

FIG. 1 illustrates exemplary components of the present invention. To facilitate a transaction using loyalty points, a user 100 engages in an on-line session with an on-line transaction system 150 to acquire or otherwise complete a transaction involving a non-tangible and/or tangible item. The transaction system provides a user interface 110 that allows the user to review information on specific non-tangible and tangible items that are available to user 100. A points calculator 120 provides information on the number of loyalty points needed to acquire various amounts of the non-tangible and tangible items. The backend processing manager 130 facilitates processing the transaction involving the non-tangible and tangible items including contacting the providers 140 of the various items and making any necessary reservations (e.g., for trips or cruises) or other arrangements (e.g., crediting the user's frequent flyer account with a particular airline) to complete the transaction. As depicted in FIG. 1, an exemplary system of the present invention may comprise various subsystems and applications. The exemplary components and users of the present invention are described below in more detail.

The user 100, as used throughout this description, should be understood to mean any software, hardware, individual, business and/or entity that desires to use any non-currency tender such as loyalty points to facilitate all or a portion of a transaction for non-tangible and/or tangible items. The user 100 may also be known as and occasionally referred to herein as a “customer,” “cardholder,” “participant,” “cardmember,” or the like. In an exemplary embodiment, although the user 100 may be an existing credit card holder, this is not required. Although the user 100 will generally be enrolled in a loyalty program, such as the American Express Membership Rewards® Program, and will have accumulated loyalty points, this is also not required.

Although the non-currency tender referred to throughout this disclosure is frequently referred to as “loyalty points,” this invention is not so limited. It should be understood the loyalty points include any type of tender, a portion or all of which may be non-currency tender, or any other identifier of value or amount. For example, coupons, frequent flyer miles, incentive awards, frequency awards, electronic tokens and/or the like. One example of loyalty points contemplated by this invention is the membership reward points awarded to participants in the American Express Membership Rewards® Program.

The providers 140 include any software, hardware, individual, business or entity which facilitates providing non-tangible and/or tangible items and thus transacts with the user 100, whether or not the transaction is directly or indirectly performed with the user 100. For example, in one embodiment, a provider 140 may be an airline such as United, wherein the user redeems loyalty points for frequent flyer mileage or for flights provided by United. In another embodiment, a provider 140 may be a partner or other entity that provides tangible items (e.g., durable goods). In yet another embodiment, a provider 140 may be a hotel or a cruise ship operator and the user 100 is redeeming loyalty points for a trip that includes a hotel stay and/or cruise. In a further embodiment, a provider 140 may be a charitable organization that receives a charitable donation from the user 100. For example, the charitable donation may result from a transaction where the user redeems loyalty points and converts them to cash or other currency-equivalent value for the charitable donation. Although certain embodiments contemplate the provider 140 being affiliated or partnered with an on-line transaction system 150, as shown in FIG. 1, this is not required. Although referred to herein as “provider,” this term contemplates situations where any second party receives a form of currency from a first party, such as, for example, where a user 100 gifts a product (e.g., e-certificate) containing a currency credit to another individual. For example, as stated above, a user 100 may desire to convert loyalty points to a currency-equivalent value to generate a charitable donation to a particular provider 140 that is a charitable organization.

The term “transaction” not only contemplates an exchange of goods or services for value from one party to another, but also the gifting of something of value from one party to another. This may be, for example, gifting of a currency value as described above or gifting of loyalty currency from a first party account to another account (e.g., to a frequent flyer account of a particular airline). An independent transaction refers to a transaction that is independent of other transactions and therefore is a transaction that may be processed even if other transactions are not completed. A dependent transaction refers to a transaction that is dependent on other transactions and therefore is a transaction that is processed only if the other transactions, upon which it depends, are completed successfully. Thus, if a transaction is not completed, then the transactions that are dependent upon it will not be processed. It will be appreciated that the transactions that are collected in a shopping cart may be independent and/or dependent transactions. Stated another way, the transactions may be related or the collected transactions may be completely dissimilar and unrelated, in which case, the only logical connection for the transactions is that they belong to the same user/customer. Additionally, transaction numbers or transaction card numbers are account numbers that are used to facilitate any type of transaction. As used herein, a “transaction card” may include any account used for financial and/or loyalty transactions wherein the account may or may not be associated with a physical card, such as a charge card, credit card, debit card, smart card, bar-coded card, magnetic stripe card, account number, Internet account, Internet card, personal digital assistant account, digital wallet account, airline card, mall card, frequent shopper card, radio frequency identification “fob” device and/or the like.

Transaction system 150 may include a host server or other computing systems including a processor for processing digital data, a memory coupled to said processor for storing digital data, an input digitizer coupled to the processor for inputting digital data, an application program stored in said memory and accessible by said processor for directing processing of digital data by said processor, a display coupled to the processor and memory for displaying information derived from digital data processed by said processor and a plurality of databases, said databases including client data, merchant data, financial institution data and/or like data that could be used in association with the present invention. As those skilled in the art will appreciate, user computer will typically include an operating system (e.g., Windows NT, 95/98/2000, Linux, Solaris, Windows XP, etc.) as well as various conventional support software and drivers typically associated with computers. User computer can be in a home or business environment with access to a network. In an exemplary embodiment, access is through the Internet through a commercially-available web-browser software package.

Communication among the user 100, the transaction system 150, and the providers 140, or additional third parties (as may be contemplated by various embodiments) may take place over any computerized network via any suitable user interface system 110 that allow for the exchange of analog or digital information. As such, these systems may include, but are not limited to, telephone interactive voice response or operator-facilitated systems, on-line or offline computer networked systems using various transfer protocols, wireless devices, personal data assistants, interactive TV, broadband, ultrawide band devices, transponders and the like. For example, the user interface system 110 may comprise web servers and applications configured to facilitate client/server communication over the Internet via any wireless or wire-based system. It will be appreciated that many applications of the present invention could be formulated. One skilled in the art will appreciate that an interface system 110 may include any network or system for exchanging data or transacting business, such as the Internet, an intranet, an extranet, WAN, LAN, satellite or wireless communications, and/or the like. The user 100 may interact with the transaction system 150 via any input device such as a telephone, keyboard, mouse, kiosk, personal digital assistant, touch screen, voice recognition device, transponder, biometrics device, handheld computer, personal data assistant (e.g., Palm Pilot®), cellular phone, web TV, web phone, blue tooth/beaming device and/or the like. Similarly, the invention could be used in conjunction with any type of personal computer, network computer, workstation, minicomputer, mainframe, or the like running any operating system such as any version of Windows, Windows NT, Windows2000, Windows 98, Windows 95, MacOS, OS/2, BeOS, Linux, UNIX, or the like. Moreover, although the invention uses protocols such as TCP/IP to facilitate network communications, it will be readily understood that the invention could also be implemented using IPX, Appletalk, IP-6, NetBIOS, OSI or any number of existing or future protocols. Moreover, the system contemplates the use, sale, exchange, transfer, or any other distribution of any goods, services or information over any network having similar functionality described herein.

The transaction system 150 may utilize any computer system for managing, tracking, and/or reporting loyalty program information. As previously described, the traditional loyalty systems allow participants to accumulate points in a loyalty program account and to then redeem points for merchandise. For example, the American Express Membership Rewards® Program allows participants to accumulate points by using their transaction card (American Express® card) to make purchases or by shopping with affiliated merchants. The transaction system 150, as contemplated by the present invention, may be a stand-alone system or may be affiliated or integrated with other loyalty programs or transaction networks. The component parts of an exemplary transaction system 150 generally include computer server and database systems for processing and storing loyalty program account information.

The backend processing system 130 is any suitable hardware and/or software configured to facilitate communication between the transaction system 150, providers 140 and/or shopping/redemption networks. In an exemplary embodiment, the backend processing system 130 is configured to, inter alia, (1) receive requests to use loyalty points as currency, via a user interface system 110, (2) verify with the transaction system 150 that sufficient loyalty points are available, (3) if necessary, communicate with the provider 140 to determine if the user 100 has an active account with the provider; and (4) interact with the provider system 140 to complete the transaction for non-tangible and/or tangible items. The backend processing system 130 may comprise various computer web and application servers, databases, routers, relays and the like in order to suitably process, route, and transmit data among, inter alia, the user interface system 110, transaction system 150 and the provider 140.

User interface system 110 includes any software and/or hardware that is suitably configured to provide the various user interfaces of the present invention so that the user can interact with the transaction system.

Points calculator 120 is any hardware and/or software suitably configured to allow a user to determine whether they have enough loyalty points to perform a transaction (e.g., for a particular item), and, if desired, to determine how many more loyalty points may be needed to acquire an item or otherwise perform a transaction.

Using a shopping cart feature of the present invention, users can add and remove items to/from a personal shopping cart. As used herein, a “shopping cart” is any data structure and associated code that facilitates tracking items that have been selected by a user for possible redemption. The shopping cart may be persistent over multiple sessions. For example, a user can modify the contents of a shopping cart over a period of time, such as a week, and then proceed to finalize the acquisition of the items by redeeming loyalty points.

Having described and defined exemplary components of the present invention, it should be appreciated that the present invention may be described herein in terms of functional block components, screen shots, optional selections and various processing steps. It should be appreciated that such functional blocks may be realized by any number of hardware and/or software components configured to perform the specified functions. For example, the present invention may employ various integrated circuit components, e.g., memory elements, processing elements, logic elements, look-up tables, and the like, which may carry out a variety of functions under the control of one or more microprocessors or other control devices. Similarly, the software elements of the present invention may be implemented with any programming or scripting language such as C, C++, Java, COBOL, assembler, PERL, extensible markup language (XML), and Microsoft's Visual Studio NET, with the various algorithms being implemented with any combination of data structures, objects, processes, routines or other programming elements. Further, it should be noted that the present invention might employ any number of conventional techniques for data transmission, signaling, data processing, network control, and the like. For a basic introduction of cryptography and network security, the following may be helpful references: (1) “Applied Cryptography: Protocols, Algorithms, And Source Code In C,” by Bruce Schneier, published by John Wiley & Sons (second edition, 1996); (2) “Java Cryptography” by Jonathan Knudson, published by O'Reilly & Associates (1998); (3) “Cryptography & Network Security: Principles & Practice” by William Stalling, published by Prentice Hall; all of which are hereby incorporated by reference.

It should be appreciated that the particular implementations shown and described herein are illustrative of the invention and its best mode and are not intended to otherwise limit the scope of the present invention in any way. Indeed, for the sake of brevity, conventional data networking, application development, database operations, and other functional aspects of the system (and components of the individual operating components of the system) and method may not be described in detail herein. Furthermore, the connecting lines shown in the various figures contained herein are intended to represent exemplary functional relationships and/or physical couplings between the various elements. It should be noted that many alternative or additional functional relationships or physical connections may be present in a practical electronic transaction system.

As will be appreciated by one of ordinary skill in the art, the present invention may be embodied as a method, a data processing system, a device for data processing, and/or a computer program product. Accordingly, the present invention may take the form of an entirely software embodiment, an entirely hardware embodiment, or an embodiment combining aspects of both software and hardware. Furthermore, the present invention may take the form of a computer program product on a computer-readable storage medium having computer-readable program code means embodied in the storage medium. Any suitable computer-readable storage medium may be utilized, including hard disks, CD-ROM, optical storage devices, magnetic storage devices, and/or the like.

The present invention is described herein with reference to screen shots, block diagrams and flowchart illustrations of methods, apparatus (e.g., systems), and computer program products according to various aspects of the invention. It will be understood that each functional block of the block diagrams and the flowchart illustrations, and combinations of functional blocks in the block diagrams and flowchart illustrations, respectively, can be implemented by computer program instructions. These computer program instructions may be loaded onto a general purpose computer, special purpose computer, or other programmable data processing apparatus to produce a machine, such that the instructions which execute on the computer or other programmable data processing apparatus create means for implementing the functions specified in the flowchart block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions specified in the flowchart block or blocks.

Accordingly, functional blocks of the block diagrams and flowchart illustrations support combinations of means for performing the specified functions, combinations of steps for performing the specified functions, and program instruction means for performing the specified functions. It will also be understood that each functional block of the block diagrams and flowchart illustrations, and combinations of functional blocks in the block diagrams and flowchart illustrations, can be implemented by either special purpose hardware-based computer systems which perform the specified functions or steps, or suitable combinations of special purpose hardware and computer instructions.

This system may be integrated with other systems to better facilitate the spending of loyalty points and the redemption of loyalty points for non-tangible and tangible items. For more information on loyalty systems, smart card systems, transaction systems, electronic commerce systems and digital wallet systems, see, for example, a system and method for using loyalty points as disclosed in Ser. No. 09/834,478, filed Apr. 13, 2001; the Shop AMEXT™ system as disclosed in Ser. No. 60/230,190, filed Sep. 5, 2000; a digital wallet system as disclosed in U.S. Ser. No. 09/652,899, filed Aug. 31, 2000; a stored value card as disclosed in Ser. No. 09/241,188, filed on Feb. 1, 1999; a system for facilitating transactions using secondary transaction numbers as disclosed in Ser. No. 09/800,461, filed Mar. 7, 2001; smart card systems as disclosed in Ser. No. 60/232,040, filed Sep. 12, 2000; a system and method for the transfer of loyalty points as disclosed in Ser. No. 10/304,251, filed Nov. 26, 2002; a system and method for the real-time transfer of loyalty points between accounts as disclosed in Ser. No. 10/378,456, filed Mar. 3, 2003; a system and method for distributing vouchers as disclosed in Ser. No. 10/378,462, filed Mar. 3, 2003; all of which are herein incorporated by reference.

Referencing the on-line aspect of an exemplary embodiment of this invention, each user may be equipped with a computing system to facilitate on-line commerce transactions. The computing units may be connected with each other via a data communication network. The network is a public network and assumed to be insecure and open to eavesdroppers. In the illustrated implementation, the network is embodied as the Internet. In this context, the computers may or may not be connected to the Internet at all times. For instance, one user's computer may employ a modem to occasionally connect to the Internet, whereas another user might maintain a permanent connection to the Internet. It is noted that the network may be implemented as other types of networks, such as an interactive television (ITV) network.

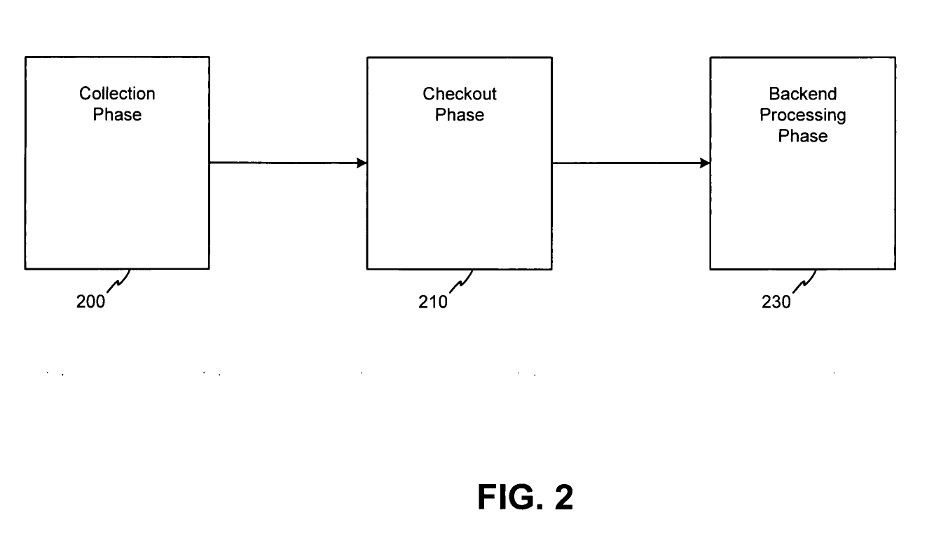

Turning now to the methods for redeeming loyalty points for transactions involving non-tangible and tangible items, FIG. 2 illustrates three exemplary phases: (1) a collection phase (step 200), (2) a checkout phase (step 210), and (3) a backend processing phase (step 230).

Collection Phase:

The collection phase may include a user's successful registration and enrollment to use the system and method of the present invention. In general, user 100 will have registered to participate in a loyalty program and will have accumulated at least some loyalty points. In an exemplary embodiment, user 100 has a transaction card associated with a financial transaction account (e.g., Discover® card, American Express® card, etc.), wherein the system that supports the loyalty program associated with the card provider is what is referred to herein as the transaction system 150. Registration and enrollment processes are known in the art, and as such, will not be discussed in-depth herein. Although an exemplary embodiment contemplates the use of, and integration of a user's loyalty account and financial transaction account, other embodiments do not necessarily require this integration.

The collection phase also may include the user browsing different non-tangible and tangible items and then selecting certain items and collecting them in the form of various transactions in the user's shopping cart. The user may view reward specific information about different items as described below.

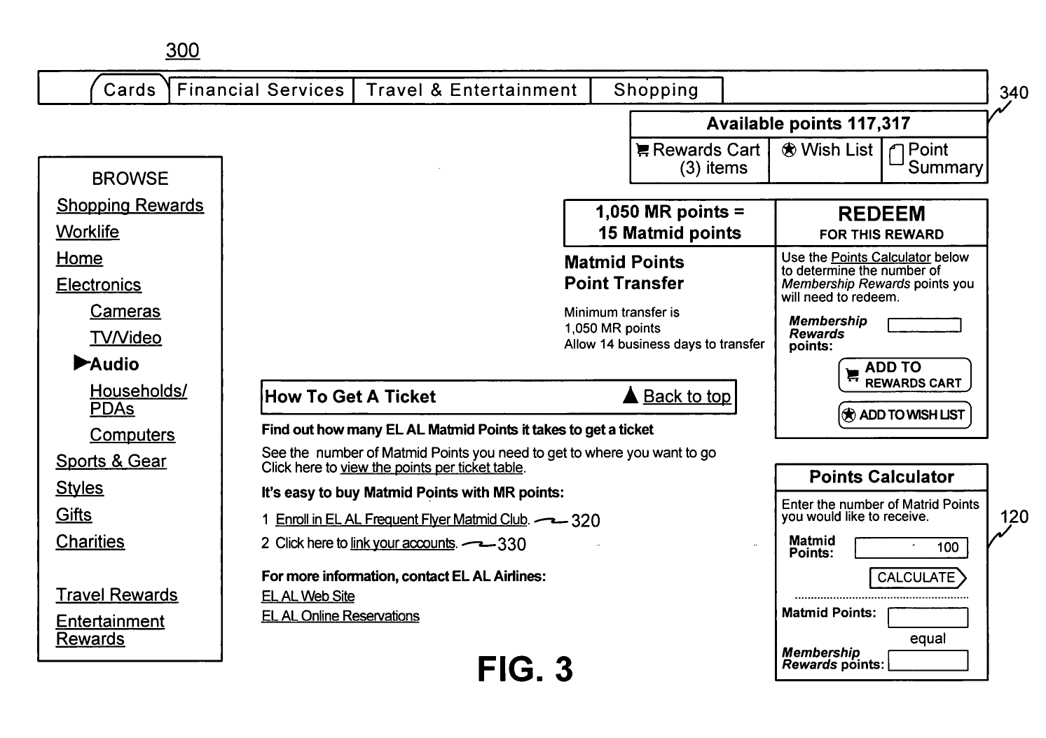

The collection phase may be facilitated using an integrated (i.e., integrated with a shopping network) or stand-alone (i.e., not integrated with a shopping network) system. A stand-alone exemplary on-line embodiment is depicted in FIGS. 3-9. With additional reference to FIG. 1, these screen shots illustrate an exemplary embodiment of the present invention utilizing a user interface system 110 suitably configured with an appropriate web server system to facilitate on-line redemption of loyalty points. FIG. 3 illustrates an exemplary user interface 300 that provides reward specific information for a non-tangible item. Here, user 100 has identified a non-tangible item (e.g., frequent flyer mileage) and selected that item in order to view reward specific information about the non-tangible item. Desiring to use loyalty points, user 100 has navigated to the transaction system 150 website and logged-in with appropriate authenticating information such as, for example, a username and password. However, it should be appreciated that in accordance with an alternative embodiment of the present invention, the user does not to have to provide authenticating information. Stated another way, the entire shopping and collection phase may be performed anonymously, and the user does not to be identified until the checkout phase. The user 100 may access a catalog of non-tangible and tangible items offered in exchange for the redemption of loyalty points. The user may select one of the non-tangible items in order to view reward specific information about the non-tangible item.

Continuing with FIG. 3, user interface 300 provides various information that facilitates the user's decision as to whether to redeem loyalty points for the selected non-tangible item. User 100 is provided with information, for example, on the conversion rate between loyalty points and the non-tangible item. In the illustrated example for E1 A1 frequent flyer mileage, this information is provided as 1,050 MR points (i.e., loyalty points)=15 Matmid points (the points used by E1 A1 for frequent flyer mileage). The conversion rate may be established or adjusted manually, in real time, randomly, at set intervals and/or based on any algorithm. The user interface system also provides a points calculator 120 that allows a user to enter a desired amount of the non-tangible item, and then the points calculator will calculate the amount of loyalty points that will need to be redeemed based on a points ratio or algorithm. In one embodiment of the present invention, the points calculator may only be displayed if the point transfer ratio is not 1:1. User interface 300 also provides a link 320 that facilitates the user enrollment in the program, if desired or necessary, that supplies the non-tangible item. A link 330 is also provided that will enable the user to “link” their frequent traveler account with transaction system 150. User interface 300 may display additional information on how to make airline reservations or how otherwise to use the non-tangible item that is to be acquired. The number of available loyalty points (340) may also be displayed in the user interface.

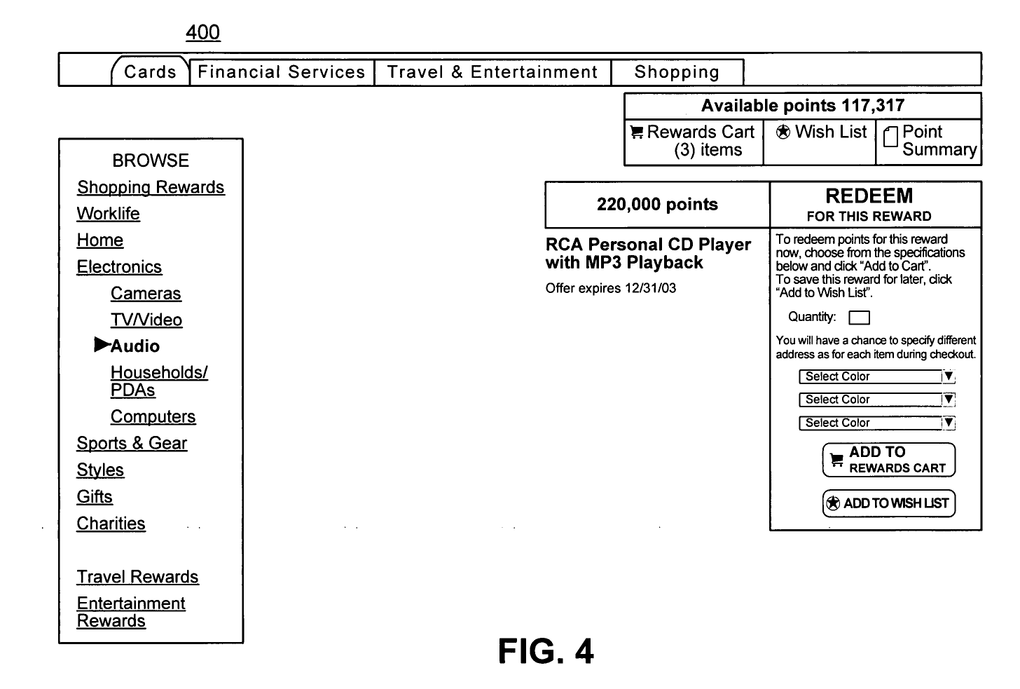

With reference to FIG. 4, user interface 400 illustrates reward specific information for a tangible item (i.e., merchandise such as a television or a book) that may be redeemed on-line in exchange for loyalty points. Similar to user interface 300, information is displayed that will facilitate a user's decision as to whether to redeem loyalty points for the selected item. In addition, the user is able to browse various tangible items and collect them in the shopping cart in the form of various transactions for the tangible items. For example, an exemplary independent transaction may be to purchase a personal CD player with MP3 feedback for a certain number of loyalty points. Exemplary dependent transactions may comprise transactions for CDs that are dependent on the CD player transaction and are for various CDs in exchange for loyalty points.

Checkout Phase:

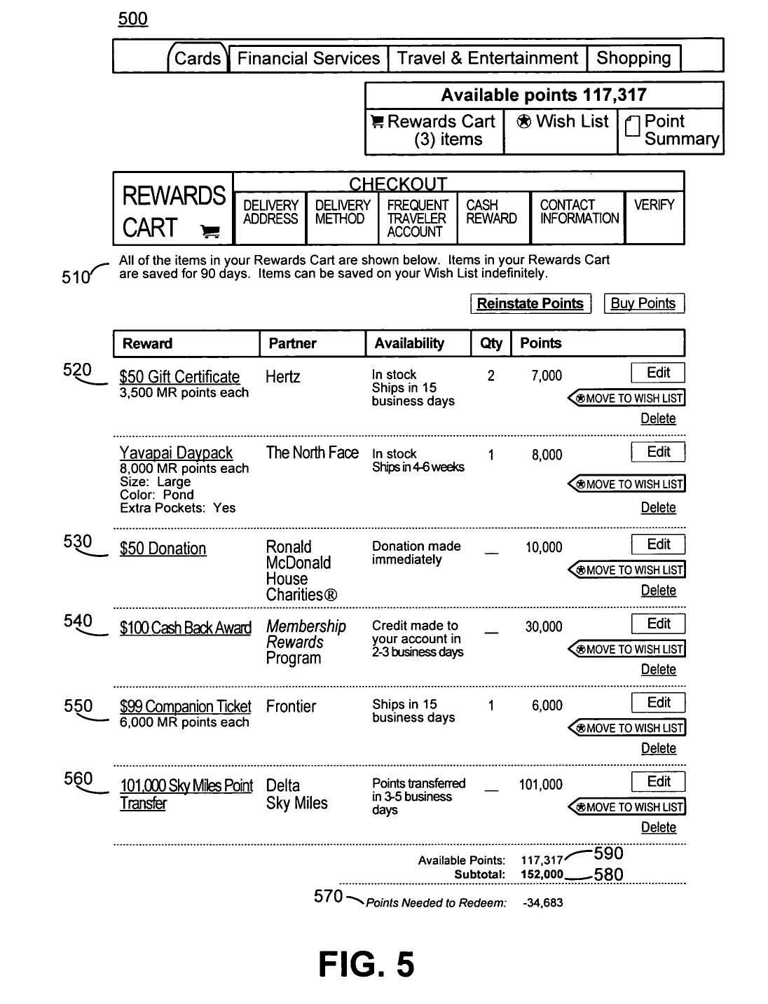

Once the user has finished collecting transactions in his/her shopping cart, or at any other desired time, the user may proceed to checkout. With reference to FIG. 5, user interface 500 illustrates an exemplary shopping cart 510 that contains transactions for various non-tangible and tangible items. For example, the non-tangible items may include a gift certificate 520, a charitable donation 530, a cash back reward 540, an airline ticket 550, frequent flyer miles 560, and transactions for transferring cash into other financial accounts such as an IRA, transactions for converting loyalty points into cash for paying bills.

The shopping cart 510 displays the total number of loyalty points that are needed to perform the collected transactions in the cart. If the user does not have enough points to perform all of the collected transactions, then the “points needed to redeem” area 570 of the cart provides the number of points needed. With continued reference to FIG. 5, area 570 represents the difference between the points displayed at “subtotal” 580 (i.e., the total number of points needed to perform all of the collected transactions) and the points that are available (area 590) (i.e., the loyalty points that the user has earned).

In order to check out, the user should have enough available points to perform all the collected transactions in the cart and the user should be enrolled with the transaction system. If the user is unable to check out during the current session, then the user can keep the transactions in his/her cart for retrieval during a later session, but the user may not be allowed to check out.

If the user does not have enough available points to check out, then the user may delete transactions from his/her shopping cart. User interface 500 will update the various areas 570, 580, 590 as each transaction is deleted. In addition, the user may move transactions for various items to his/her wish list. Once the “points needed to redeem” reaches zero, then the user may proceed with checking out. Alternatively, the user may obtain additional points in his/her loyalty point account by, for example, transferring points from or otherwise linking to another loyalty point account in the same or different system.

Before completing the checkout process, the user may verify the accuracy of all information that he/she has entered for redemption. For example, the user may change the delivery address or the mode of delivery (that is, expedited delivery, standard delivery, etc.).

Background Processing Phase:

Upon completion of checkout, the backend processing system 130 processes each transaction in the shopping cart and completes the transaction for each tangible and/or non-tangible item. The backend processing system 130 is configured to, inter alia, (1) receive requests to use loyalty points as currency, via a user interface system 110, (2) verify with the transaction system 150 that sufficient loyalty points are available, (3) if necessary, communicate with the provider 140 to determine if the user 100 has an active account with the provider; and (4) interact with the provider system 140 to complete the transaction for non-tangible and/or tangible items.

Backend processing system 130 may interact with providers 140 via e-mail, application program interface (API), and the like. In accordance with one embodiment of the present invention, backend processing system 130 may utilize a partner that serves as a clearinghouse for distributing the tangible items that are acquired by processing the various transactions. For transactions that involve a redemption of loyalty points for cash (such as a charitable donation or making a contribution to an IRA account), a cash credit may be placed in the user's transaction card account and then the cash credit may be used to complete the transaction, such as, for charitable donations or for contributions to a financial account such as an IRA.

As stated above, the collected transactions may be independent or dependent. An independent transaction refers to a transaction that is independent of other transactions and therefore is a transaction that may be processed even if other transactions are not completed. A dependent transaction refers to a transaction that is dependent on other transactions and therefore is a transaction that is processed only if the other transactions, upon which it depends, are completed successfully. Thus, if a transaction is not completed, then the transactions that are dependent upon it will not be processed. It will be appreciated that the transactions that are collected in a shopping cart may be independent and/or dependent transactions. Stated another way, the transactions may be related or the collected transactions may be completely dissimilar and unrelated, in which case, the only logical connection for the transactions is that they belong to the same user/customer.

In the foregoing specification, the invention has been described with reference to specific embodiments. However, it will be appreciated that various modifications and changes can be made without departing from the scope of the present invention. The specification and figures are to be regarded in an illustrative manner, rather than a restrictive one, and all such modifications are intended to be included within the scope of the present invention. For example, the steps recited in any of the method or process claims may be executed in any order and are not limited to the order presented.

Benefits, other advantages, and solutions to problems have been described above with regard to specific embodiments. However, the benefits, advantages, solutions to problems, and any element(s) that may cause any benefit, advantage, or solution to occur or become more pronounced are not to be construed as critical, required, or essential features or elements of any or all the claims. As used herein, the terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. Further, no element described herein is required for the practice of the invention unless expressly described as “essential” or “critical.”

1. In a computer system that provides user access to a database of tangible and non-tangible items, and provides electronic shopping carts for allowing users to interactively select and hold transactions for the tangible and non-tangible items from the database, a method for redeeming loyalty points, comprising:
identifying a transaction for an item;
collecting the transaction in the user's electronic shopping cart;
repeating the steps of identifying and collecting transactions until the user is ready to check out;
verifying an amount of loyalty points for the collected transactions; and
proceeding to an electronic checkout for completing the collected transactions.

2. The method of claim 1, wherein the collected transactions comprise independent and dependent transactions.

3. The method of claim 1, wherein the collected transactions comprise transactions for non-tangible items and transactions for tangible items.

4. In a computer system that provides user access to a database of tangible and non-tangible items, a method for facilitating the redemption of loyalty points, comprising:
accessing a specified item;
providing an amount of loyalty points needed to complete a transaction for the specified item;
providing an electronic shopping cart for collecting one or more transactions for the specified items;
verifying an amount of loyalty points for the collected transactions; and
processing each of the collected transactions.

5. The method of claim 4, wherein the processing each of the collected transactions includes:
converting the amount of loyalty points for the transaction into a currency value;
contacting the provider of the item for the transaction; and
providing the currency value to the provider of the item to complete the transaction.

6. The method of claim 4, further comprising providing an amount of loyalty points accumulated by the user.

7. The method of claim 4, wherein the collected transactions comprise independent and dependent transactions.

8. The method of claim 4, wherein the collected transactions comprise transactions for non-tangible items and transactions for tangible items.
